(19) United States
(12) Patent Application Publication
(10) Pub. No.: US 2020/0341294 A1
(43) Pub. Date: Oct. 29, 2020

(54) DETACHABLE NOSE PAD ASSEMBLY FOR EYEGLASSES

(71) Applicants: YUNG-CHING CHENG, TAINAN CITY (TW); YUNG-MING CHENG, TAINAN CITY (TW)

(72) Inventors: YUNG-CHING CHENG, TAINAN CITY (TW); YUNG-MING CHENG, TAINAN CITY (TW)

(21) Appl. No.: 16/392,801

(22) Filed: Apr. 24, 2019

(51) Int. Cl. G02C 5/12

(52) U.S. Cl. CPC G02C 5/126; G02C 2200/06

(57) ABSTRACT

The present invention discloses a detachable nose pad assembly for eyeglasses which comprises a nose pad having a socket for detachably assembling to a middle region of a frame, and a mounting stand disposed on the frame and corresponding to the socket. The mounting stand has a U-shaped flexible member having an upper clipping portion and a lower clipping portion disposed thereon for inserting into the socket, two notches disposed at two laterals of the U-shaped flexible member respectively and two supporting ribs respectively extended from an outside of each of the two notches. The socket has a concave groove for engaging with the lower clipping portion and a U-shaped wall formed at an end surface thereof for correspondingly inserting into the two notches and positioned by the two supporting ribs.

### BACKGROUND OF THE INVENTION

### 1. Field of the Invention

The present invention relates to a detachable nose pad assembly for eyeglasses which is detachably engaged with a frame of a pair of eyeglasses according to a user's need for resting the eyeglasses on a nose of the user stably.

### 2. Description of Related Art

A traditional nose pad of a pair of eyeglasses is disposed at an inner side of a frame of the eyeglasses and fixed by screws or formed integrally with the frame. When a user wears the eyeglasses, the traditional nose pad disposed in a middle region of the frame is directly rested on a nose bridge of the user. However, the traditional nose pad fixed on the frame cannot be replaced by other nose pads according to the user's need, so a height and angle of the traditional nose pad are fixed and cannot be adjusted. Since the height and width of the nasal bridge of each user are different, the traditional non-adjustable nose pads cannot stably rest on the nasal bridge of each user and the eyeglasses are easily slid down from the nasal bridges of the users. Furthermore, the traditional nose pad is anchored by screws and is not beautiful in appearance.

In order to solve the abovementioned problems, an adjustable nose pad structure of the Taiwan Pat. No. TW M534829 (U), issued on 1 Jan. 2017 has been disclosed. It mainly comprises a frame and a nose pad. The frame has a socket recessed at a middle region thereof and an engaging slot formed at a bottom of the socket. The nose pad has a metal frame, a soft cushion wrapping the metal frame and a flexible insert member corresponding to the socket of the frame. The flexible insert member has an engaging protrusion corresponding to the engaging slot of the socket for inserting the flexible insert member into the socket to assemble the engaging protrusion with the engaging slot.

A nose pad assembly of the Taiwan Pat No. TW M573843 (U), issued on 2 Feb. 2019, mainly comprises a frame and a nose pad. The frame has a bridge disposed in an inner middle region thereof, a slot disposed in the bridge, and an engaging portion disposed in a middle of the slot. The nose pad has a positioning rib corresponding to the slot for inserting into the slot, a hook disposed on the positioning rib for fastening to the engaging portion, and two soft pads respectively extended from two sides of the positioning rib for resting on a user's nose.

The nose pads described above are assembled to the frame by a socket or a slot for positioning. However, each of the nose pads is assembled to the frame by only one anchor point, so the two laterals of each of the nose pads are not limited or positioned, and the nose pads are easily moved left and right or loosen and swayed when using. Therefore, it is not comfortable for the user to wear the eyeglasses having the nose pad described above, and the structure of the abovementioned nose pad needs to be improved.

### SUMMARY OF THE INVENTION

The present invention provides a detachable nose pad assembly for eyeglasses which is detachably engaged with a frame of a pair of eyeglasses for easily changing different colors, styles, hardness or characteristics according to a user's need so the present invention is comfortable to wear and has beautiful appearance.

The detachable nose pad assembly for eyeglasses of the present invention comprises a U-shaped wall which is inserted into two notches disposed at two laterals and two supporting ribs respectively extended from an outside of each of the two notches for limiting and positioning the U-shaped wall. Therefore, the U-shaped wall inserted into the two notches and limited by the supporting ribs can stabilize the detachable nose pad assembly for eyeglasses without swaying when using.

In addition, the user can replace the detachable nose pad assembly for eyeglasses easily by a U-shaped flexible member.

### BRIEF DESCRIPTION OF THE DRAWINGS

FIG. 1 is an exploded diagram showing a detachable nose pad assembly for eyeglasses of the present invention;

FIG. 2 is a stereogram showing a detachable nose pad assembly for eyeglasses of the present invention;

FIG. 3 is a sectional stereogram showing a detachable nose pad assembly for eyeglasses of the present invention.

### DETAILED DESCRIPTION OF THE PREFERRED EMBODIMENT

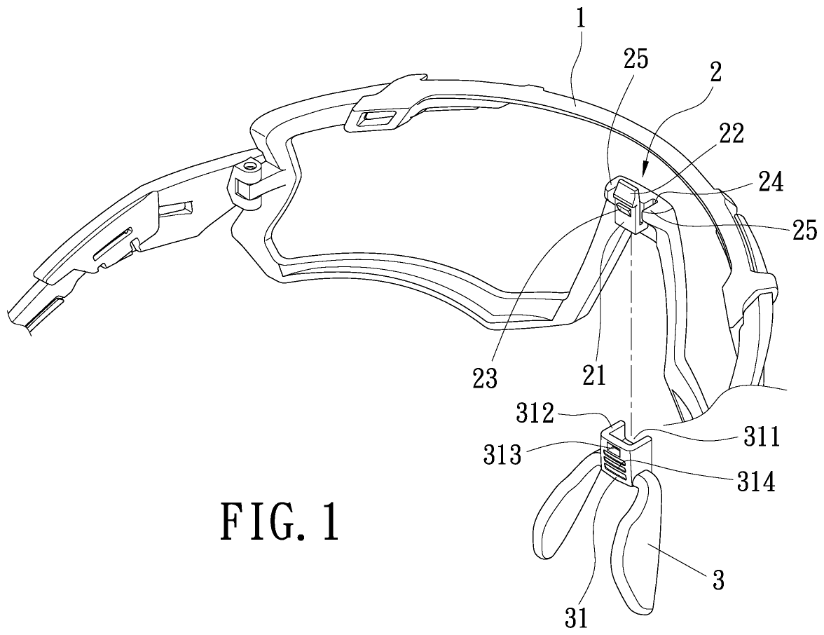

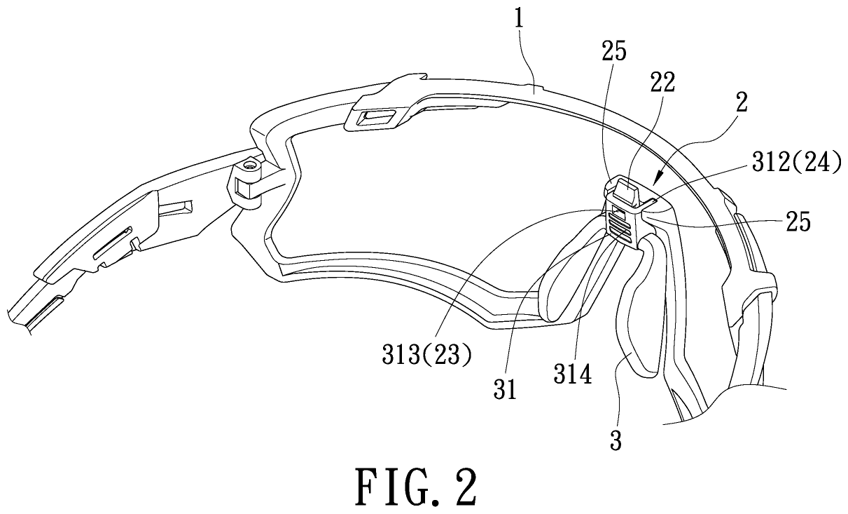

Referring to FIG. 1 and FIG. 2, a detachable nose pad assembly for eyeglasses of the present invention comprises a mounting stand (2) disposed at a middle region of a frame (1) of eyeglasses and a nose pad (3) detachably engaged with the mounting stand (2).

The mounting stand (2) has a U-shaped flexible member (21), an upper clipping portion (22) disposed at one terminal of the U-shaped flexible member (21), a lower clipping portion (23) disposed on the U-shaped flexible member (21) corresponding to the upper clipping portion (22), two notches (24) disposed at two laterals of the U-shaped flexible member (21) respectively and two supporting ribs (25) respectively extended from an outside of each of the two notches (24).

The nose pad (3) comprises a socket (31) corresponding to the mounting stand (2). The socket (31) has an open slot (311) for engaging with the U-shaped flexible member (21), a U-shaped wall (312) formed at an end surface of the socket (31) for correspondingly inserting into the two notches (24) and is positioned by the two supporting ribs (25), and a concave groove (313) disposed on the U-shaped wall (312) for positioning and engaging with the lower clipping portion (23), and the upper clipping portion (22) contacts a top surface of the U-shaped wall (312).

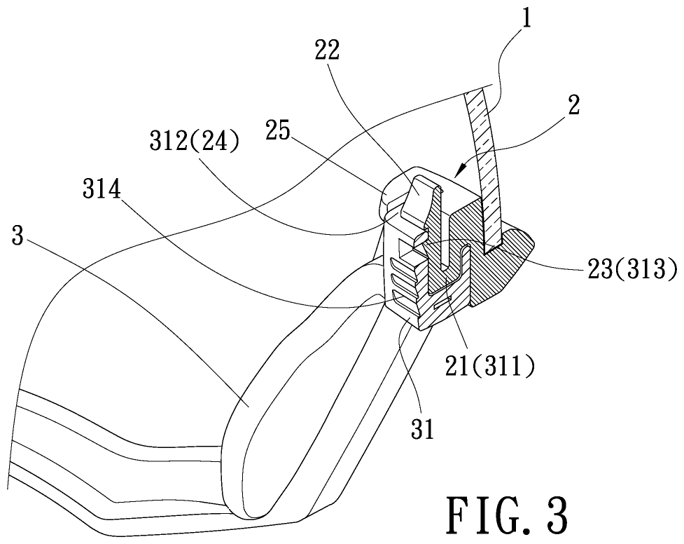

Referring to FIG. 1 to FIG. 3, the nose pad (3) is installed on the frame (1) of eyeglasses by engaging the U-shaped flexible member (21) of the mounting stand (2) with the open slot (311) of the socket (31) of the nose pad (3). The lower clipping portion (23) on the U-shaped flexible member (21) is then correspondingly engaged with the concave groove (313), and the upper clipping portion (22) is contacted the top surface of the U-shaped wall (312) of the socket (31) to clip the socket (31) stably. At the same time, the U-shaped wall (312) of the socket (31) is correspondingly inserted into the two notches (24) disposed at two laterals of the U-shaped flexible member (21) and is positioned by the two supporting ribs (25) extended from the outside of each of the two notches (24). Therefore, the nose pad (3) is engaged with the mounting stand (2) on the frame (1) of eyeglasses stably without swaying when using.

To replace the nose pad (3) for changing different colors, styles, hardness or characteristics according to a user's need, the U-shaped flexible member (21) is pressed and deformed for detaching the upper clipping portion (22) from top surface of the U-shaped wall (312) and releasing the lower clipping portion (23) from the concave groove (313). The socket (31) of the nose pad (3) is then pulled down to separate the open slot (311) from the U-shaped flexible member (21) for removing the nose pad (3). At last, a nose pad (3) to be replaced is assembled to the eyeglasses according to the procedure described above so as to achieve a purpose of replacing the nose pad (3) for eyeglasses.

The socket (31) is further provided with a non-slip portion (314) on a surface of the socket (31) for a user to hold the socket (31) firmly without slipping when replacing the nose pad (3).

The present invention has advantages below:

1. The detachable nose pad assembly for eyeglasses of the present invention can be easily replaced by a design of the U-shaped flexible member for changing different colors, styles, hardness or characteristics according to a user's need, so the present invention is comfortable to wear and has beautiful appearance.

2. The detachable nose pad assembly for eyeglasses of the present invention can be replaced easily by a user due to flexibility of the U-shaped flexible.

3. The U-shaped wall of the nose pad is inserted into the two notches and positioned by the two supporting ribs to stabilize the detachable nose pad assembly for eyeglasses without swaying when using.

What is claimed is:

1. A detachable nose pad assembly for eyeglasses, comprising:
a mounting stand disposed at a middle region of a frame of eyeglasses and having a U-shaped flexible member, an upper clipping portion disposed at one terminal of the U-shaped flexible member, a lower clipping portion disposed on the U-shaped flexible member corresponding to the upper clipping portion, two notches disposed at two laterals of the U-shaped flexible member respectively and two supporting ribs respectively extended from an outside of each of the two notches; and
a nose pad having a socket corresponding to the mounting stand, wherein the socket has an open slot for engaging with the U-shaped flexible member, a U-shaped wall formed at an end surface thereof for correspondingly inserting into the two notches and positioned by the two supporting ribs, and a concave groove disposed on the U-shaped wall for positioning and engaging with the lower clipping portion, and wherein the upper clipping portion contacts a top surface of the U-shaped wall.

2. The detachable nose pad assembly for eyeglasses as claimed in claim 1, wherein the socket is provided with a non-slip portion on a surface thereof.
